(19) United States
(12) Patent Application Publication
(10) Pub. No.: US 2017/0048055 A1
(43) Pub. Date: Feb. 16, 2017

(54) METHOD AND APPARATUS FOR COMMUNICATING DATA ON PHYSICAL DOWNLINK SHARED CHANNEL

(71) Applicant: Samsung Electronics Co., Ltd., Suwon-si, Gyeonggi-do (KR)

(72) Inventors: Jingxing FU, Beijing (CN); Yingyang LI, Beijing (CN); Shichang ZHANG, Beijing (CN)

(21) Appl. No.: 15/306,628

(22) PCT Filed: Apr. 24, 2015
(86) PCT No.: PCT/KR2015/004099

§ 371 Date: Oct. 25, 2016

(30) Foreign Application Priority Data
Apr. 25, 2014 (CN) 201410171110.4

(51) Int. Cl. H04L 5/14; H04L 1/18; H04L 5/00; H04W 72/04

(52) U.S. Cl. CPC H04L 5/14; H04W 72/042; H04L 1/1812; H04L 1/1854; H04W 72/0446; H04L 5/0055

(57) ABSTRACT

Embodiments of the present disclosure provide a method for communicating data on PDSCH, including: receiving, by a user equipment (UE), configuration information, with which the UE works in a flexible duplex (FD) mode; receiving, by the UE, data of a PDSCH and control data of a physical downlink control channel (PDCCH) or enhanced physical downlink control channel (EPDCCH) indicating downlink (DL) semi-persistent scheduling (SPS) release according to a scheduling mode of the FD mode; and feeding back, by the UE, hybrid automatic repeat request-acknowledge (HARQ-ACK) information according to a corresponding HARQ-ACK timing. An embodiment of the present disclosure may further disclose a user device. With the present disclosure, the UL and DL peak rate of the user may be enhanced and the throughput of the system may be enhanced.

### TECHNICAL FIELD

The present disclosure relates a radio communication system technology, and more particularly, to a physical downlink shared channel (PDSCH) transmission method and device on a pair of carriers.

### BACKGROUND ART

The long term evolution (LTE) system of a 3rd generation partnership project (3GPP) standardization organization supports frequency division duplexing (FDD) and time division duplex (TDD). As for the above two duplex modes, length of each radio frame is 10 ms. The radio frame includes ten sub-frames, each of which is 1 ms. Each sub-frame consists of two consecutive time slots, each of which is 0.5 ms. That is, the k-th sub-frame includes: time slot (2k) and time slot (2k+1).

As for an LTE FDD system, uplink (UL) and downlink (DL) transmission is borne by two symmetrical spectra. Therefore, at each moment, a UL sub-frame and a DL sub-frame may co-exist. As for an LTE TDD system, the UL and DL transmission is borne by a same spectrum. The UL transmission and the DL transmission may be distinguished by time. That is, different sub-frames of system frames are respectively defined as a UL sub-frame, DL sub-frame or a special sub-frame (a sub-frame consisting of a downlink pilot time slot (DwPTS), a guard period (GP) and an uplink pilot time slot (UpPTS)) according to different configurations. The existing LTE TDD system supports seven kinds of UL and DL configurations. Referring to table 1, D represents a DL sub-frame, U represents a UL sub-frame and S represents a special sub-frame.

TABLE 1

| Config- | | | | | | | | | | | |
|---|---|---|---|---|---|---|---|---|---|---|---|
| uration | Conversion | Sub-frame sequence number | | | | | | | | | |
| number | point period | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Table 1 TDD UL and DL Configuration

As for a TDD single service cell system, control data of a physical downlink control channel (PDCCH) or control data of an enhanced physical downlink control channel (EPDCCH) may be received on a sub-frame (n−k) of a same carrier and data of a physical downlink shared channel (PDSCH) may be further received on the sub-frame (n−k) of the same carrier. As shown in FIG. 1, a hybrid automatic repeat request-acknowledge (HARQ-ACK) of the PDSCH may be fed back on a UL sub-frame n of a same carrier. As shown in table 2, as for a TDD system, a value of k is determined by a TDD UL and DL configuration.

TABLE 2

| Configuration | Sub-frame sequence number n | | | | | | | | | |
|---|---|---|---|---|---|---|---|---|---|---|
| number | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, | — | — | — | — | — | — | — |
| | | | 5, 4, 11, 6 | | | | | | | |
| 6 | — | — | 7 | 7 | 5 | — | — | 7 | 7 | — |

Table 2 Index K: {k₀, k₁, . . . k_{M-1}} of a DL Associate Set of the TDD System

As for an FDD single service cell system, as shown in FIG. 2, data of the PDSCH and control data of the PDCCH or EPDCCH indicating DL semi-persistent scheduling (SPS) release may be received on a sub-frame (n−k) of a DL carrier and an HARQ-ACK of the PDSCH may be fed back on a UL sub-frame n of a UL carrier. As for an FDD system, the value of K equals to 4. The HARQ-ACK information of multiple DL sub-frames is transmitted on a same UL sub-frame. These DL sub-frames belong to a same HARQ-ACK DL associate set. That is, these DL sub-frames belong to a same HARQ-ACK bundle window. The DL associate set may be described in detail in the 3GPP 36.213. That is, a set of all DL sub-frames transmitting the HARQ-ACK information on the PUCCH of a same UL sub-frame is called the DL associate set.

With the enhancement of requirements put forward by a user on transmission rate of the data, LTE-A technologies are developed. In the LTE-A, as for the TDD system, a TDD re-configuration technology is introduced, i.e. the TDD UL and DL configuration is dynamically adjusted via signaling so that a ratio of UL sub-frames and DL sub-frames is more aligned with a ratio of UL service amount and DL service amount, which benefits a UL and DL peak rate of the user and increases throughput of the system. As for the FDD system, the UL and DL may adopt different carriers. When the UL service amount and the DL service amount is unbalanced, such as the DL service mount is more than the UL service amount, UL carrier resources of the FDD may be wasted. Therefore, it may be taken into consideration that some sub-frames in the FDD UL carrier may be used as the DL sub-frames, which is called a hybrid duplex system. This technology may enhance the UL and DL peak rate of the user and enhance the throughput of the system.

In the LTE-A, multiple component carriers (CC)s may be combined, i.e., carrier aggregation (CA) to obtain more bandwidth to form UL and DL links of the communication system and support a higher transmission rate. As for a UE, an eNB make a configuration to make the UE work in multiple cells. One of the cells is a primary cell (Pcell) and the other cells are secondary cells (Scell)s. A PDSCH of a cell may be scheduled by an (E)PDCCH transmitted by the same cell, which is called self-scheduling. In another example, the PDSCH of the cell may be scheduled by an (E)PDCCH transmitted by another cell, which is called cross-carrier scheduling. The cell transmitting the (E)PDCCH is called a scheduling cell and the cell transmitting the PDSCH is called a scheduled cell.

However, the scheduling method of the DL sub-frame in the FDD UL carrier, the scheduling method of the DL sub-frame in the FDD DL carrier and the transmission method of the HARQ-ACK information of the DL sub-frame are to-be-researched problems.

### DISCLOSURE OF INVENTION

### Technical Problem

In the conventional FDD system, each cell may include a pair of carriers, which may respectively be used for UL transmission and DL transmission. In the conventional FDD system, the duplex direction of each carrier is fixed and the bandwidth of the two carriers is the same. That is, the ratio of the UL physical resource and the DL physical resource is 1:1. However, as for practical services, in most situations, the DL services are significantly more than the UL services. For instance, the DL services are 37 times the amount of the UL services.

### Solution to Problem

In accordance with one aspect of the present disclosure, a method for communicating data on physical downlink shared channel (PDSCH) is provided. The method is includes: receiving, by a user equipment (UE), configuration information, with which the UE works in a flexible duplex (FD) mode, receiving, by the UE, data of a PDSCH and control data of a physical downlink control channel (PDCCH) or enhanced physical downlink control channel (EPDCCH) indicating downlink (DL) semi-persistent scheduling (SPS) release according to a scheduling mode of the FD mode, and feeding back, by the UE, hybrid automatic repeat request-acknowledge (HARQ-ACK) information according to a corresponding HARQ-ACK timing.

In accordance with one aspect of the present disclosure, a user device is provided. The user device is includes: a configuration module, a receiving module and a feedback module wherein the configuration module is to receive configuration information, with which a UE works in a flexible duplex (FD) mode, the receiving module is to receive data of a physical downlink shared channel (PDSCH) and control data of a physical downlink control channel (PDCCH) or enhanced physical downlink control channel (EPDCCH) indicating downlink (DL) semi-persistent scheduling (SPS) release according to a scheduling mode of the FD mode, and the feedback module is to feed back hybrid automatic repeat request-acknowledge (HARQ-ACK) information according to an HARQ-ACK timing.

### Advantageous Effects of Invention

Embodiments of the present disclosure provide a PDSCH transmission method and device, by which DL data may be transmitted in some sub-frames in a UL carrier of the FDD, UL and DL peak rate of the user may be enhanced and throughput of the system may be enhanced.

### BRIEF DESCRIPTION OF DRAWINGS

FIG. 1 is a diagram illustrating HARQ-ACK timing of a TDD system;

FIG. 2 is a diagram illustrating HARQ-ACK timing of an FDD system;

FIG. 3 is a flow chart illustrating a PDSCH scheduling method in accordance with an embodiment of the present disclosure;

FIG. 4 is diagram illustrating an HARQ-ACK timing in accordance with an embodiment of the present disclosure;

FIG. 5 is a diagram illustrating another HARQ-ACK timing in accordance with an embodiment of the present disclosure;

FIG. 6 is a diagram illustrating another HARQ-ACK timing in accordance with an embodiment of the present disclosure;

FIG. 7 is a diagram illustrating a soft buffer in accordance with an embodiment of the present disclosure; and

FIG. 8 is a diagram illustrating structure of a user device in accordance with an embodiment of the present disclosure.

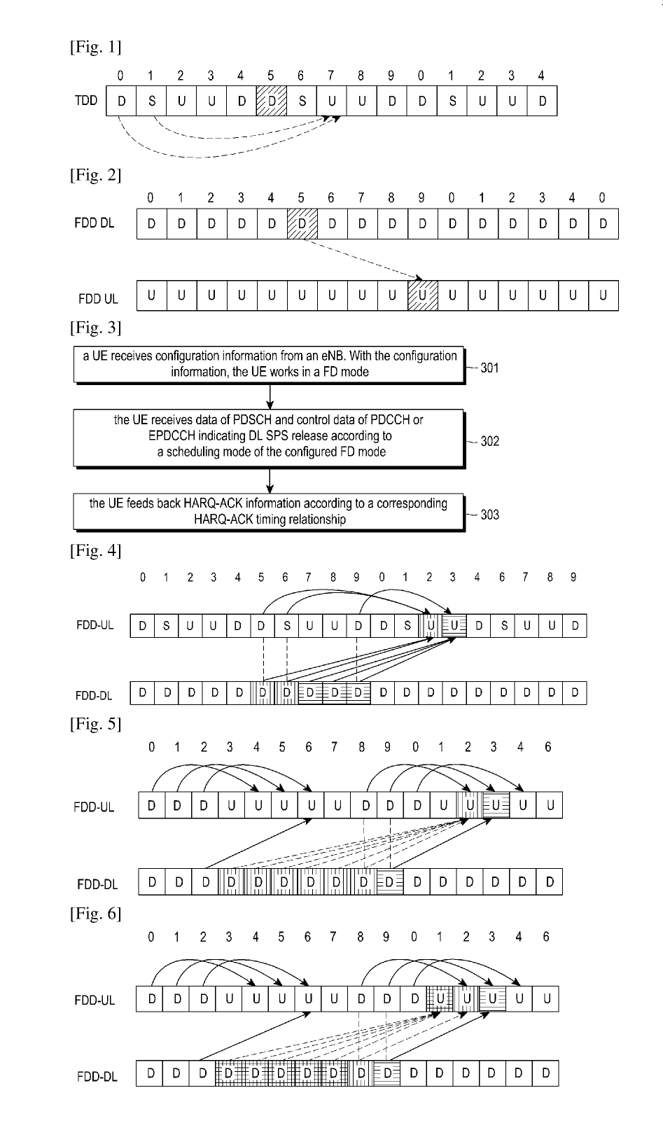

### MODE FOR THE INVENTION

To make the objective and technical solution of the examples of the present disclosure more apparent, the present disclosure may be described in detail with reference to accompanying figures.

In the conventional FDD system, each cell may include a pair of carriers, which may respectively be used for UL transmission and DL transmission. In the conventional FDD system, the duplex direction of each carrier is fixed and the bandwidth of the two carriers is the same. That is, the ratio of the UL physical resource and the DL physical resource is 1:1. However, as for practical services, in most situations, the DL services are significantly more than the UL services. For instance, the DL services are 37 times the amount of the UL services.

In order to match the change of the UL and DL services, as for a cell formed by two carriers, sub-frames of two duplex directions may be allocated to one of the carriers. In another example, it may be allowed that sub-frames of two duplex directions may be respectively allocated to each carrier. Here, two carriers of the cell may be a pair of carriers, which may be applied to the FDD cell. The two carriers of the cell may not be limited to the pair of carriers, which may be applied to the FDD cell. In the present disclosure, such system may be called a flexible duplex (FD) system. Accordingly, such cell may be called a FD cell. A UE supporting the FD scheme may be called a FD UE.

FIG. 3 is a flow chart illustrating a method for communicating data on a PDSCH in accordance with an embodiment of the present disclosure. Following blocks are included.

In block 301, a UE may receive configuration information from an eNB. With the configuration information, the UE may work in a FD mode.

In block 302, the UE may receive data of PDSCH and control data of PDCCH or EPDCCH indicating DL SPS release according to a scheduling mode of the configured FD mode.

In block 303, the UE may feed back HARQ-ACK information according to a corresponding HARQ-ACK timing.

In this embodiment of the present disclosure, as for a FD cell, a pair of carriers of the FD cell may be respectively recorded as FD-DL and FD-UL. When a backward FDD UE may access the FD cell, the FD-DL is used for DL transmission of the backward FDD UE. The FD-UL may be used for the UL transmission of the backward FDD UE. According to requirements of the service, in a typical scenario, the DL services may be more than the UL services. Therefore, some sub-frames of the FD-UL may be used for transmitting DL data. However, in some special scenario, the UL service may be more than the DL services, in this situation, some sub-frames of the FD-DL may be used for transmitting UL data.

According to the above analysis, in order to adapt to changes in business, there may be following situations.

The first situation may be that change of the UL or DL direction may be performed for some sub-frames of the FD-UL carrier and the direction of all sub-frames of the FD-DL may be fixed as the DL.

The second situation may be that the UL or DL direction of two carriers (FD-UL or FD-DL) of the FD cell may be changed. However, when the UL or DL direction of some sub-frames of one of the two carriers is changed, the UL or DL direction of all sub-frames of the other carrier is kept unchanged.

As for the above second situation, when the needed UL sub-frame resources are less than or equal to the needed DL sub-frame resources, in one period, some sub-frames in the FD-UL may be configured as the DL sub-frames or special sub-frame and all sub-frames in the FD-DL are DL sub-frames. When the needed UL sub-frame resources are more than the needed DL sub-frame resources, in one period, the direction of all sub-frames in the FD-UL may be UL and some sub-frames in the FD-DL may be configured as the UL sub-frames. The above period may be fixed number of sub-frames, one radio frame or multiple radio frames.

The technical scheme of the present disclosure may be described in detail hereinafter via several preferred embodiments.

### Embodiment One

In this embodiment, the UL or DL direction of some sub-frames of the FD-UL carrier may be changed. The sub-frames of the FD-UL carrier may be changed to DL sub-frames or special sub-frames, while all sub-frames of the FD-DL may be configured as the DL sub-frames. The UE may obtain sub-frame configuration information of the FD-UL carrier via receiving system information or high-layer signaling. The sub-frame configuration information may include: position of a sub-frame, the UL or DL direction of which may be changed, in the FD-UL carrier.

A sub-frame configuration mode of the FD-UL carrier may be that some sub-frames of the FD-UL radio frame may be changed as the DL sub-frames or special sub-frames and the changed UL and DL sub-frames are distributed in a period of 10 ms. For instance, the changed UL and DL distribution of each radio frame may be one of the current seven TDD UL and DL configurations, such as TDD UL and DL configuration A, A=0, 1, 2, 3, 4, 5 or 6, or sub-frame distribution including 7, 8, 9 or 10 UL sub-frames in the period of 10 ms.

Another sub-frame configuration mode of the FD-UL carrier may be that some sub-frames of the FD-UL carrier may be changed as the DL sub-frames or special sub-frames and the changed DL sub-frames or special sub-frames are distributed in a preset period. For instance, the DL sub-frames or special sub-frames may be distributed in a period of 40 ms. The specific distribution method may be indicated by a bitmap configured with high-layer signaling. The bitmap may include 40 bit information and equal to a sub-frame configuration period. The value of each bit of the bitmap may correspond to the UL or DL direction of the corresponding sub-frame. For instance, bit “0” may indicate the DL sub-frame or special sub-frame (“0” in front of conversion points of “0” and “1” in the bitmap may indicate that the sub-frame is the special sub-frame, the same below) and bit “1” may indicate the UL sub-frame. In another example, taking 8 ms as the distribution period, the specific distribution method may be indicated by the bitmap configured with the high-layer signaling. The bitmap may include 8 bit information and equal to the sub-frame configuration period. The value of each bit of the bitmap may correspond to the UL or DL direction of the corresponding sub-frame. For instance, bit “0” may indicate the DL sub-frame or special sub-frame (“0” in front of the conversion points of “0” and “1” in the bitmap may indicate that the sub-frame is the special sub-frame, the same below) and bit “1” may indicate the UL sub-frame.

If the UL and DL distribution of the FD-UL carrier is one of the current seven TDD UL and DL configurations, a method for determining HARQ-ACK timing may include that the HARQ-ACK timing of the DL sub-frames in the FD-UL may follow the TDD UL and DL configuration A and may be transmitted in the UL sub-frame of the FD-UL.

As for the DL sub-frame m in the FD-DL, if the sub-frame m in the FD-UL is the DL sub-frame or special sub-frame, the DL sub-frame m in the FD-DL may follow the HARQ-ACK timing of the TDD UL and DL configuration A. That is, the UE may receive the data of the PDSCH or control data of the PDCCH or EPDCCH indicating DL SPS release in a sub-frame (n−k) of the UL carrier, i.e., FD-DL and feed back the HARQ-ACK of the PDSCH in a UL sub-frame n of the UL carrier, i.e. FD-UL. The values of k may be figures without parentheses, shown in table 3. The sub-frames in the bundle window are sorted from the front to the back according to sequence number of the sub-frames. The configuration number in the table may refer to the sequence number of the TDD UL and DL configurations of the FD-UL.

As for the DL sub-frame m in the FD-DL, when the HARQ-ACK timing of the DL sub-frames in the FD-UL follow the TDD UL and DL configurations 1 to 5, if the sub-frame m in the FD-UL is the UL sub-frame and the HARQ-ACK timing of the DL sub-frame m in the FD-DL follows the HARQ-ACK timing of the first DL sub-frame behind the sub-frame m in the FD-UL, the UE may receive the data of the PDSCH and the control data of the PDCCH or EPDCCH indicating the DL SPS release in the sub-frame (n−k) of the DL carrier, i.e. FD-DL and feed back the HARQ-ACK of the PDSCH in the UL sub-frame n of the UL carrier, i.e. the FD-UL. The values of k may be figures in parentheses, shown in table 3. The configuration number may refer to the sequence number of the TDD UL and DL configuration of the FD-DL and the sub-frames in the bundle window are sorted from the front to the back according to sequence number of the sub-frames. As shown in table 4, other sub-frames in the bundle window may be sorted from the front to the back according to the sequence number of the sub-frames except for the special sub-frames and special sub-frames may come last. Meaning of figures without the parentheses and figures in the parentheses in table 4 may be the same as those in table 3. The configuration number in the table may be the sequence number of the TDD UL and DL configuration of the FD-UL.

As for the DL sub-frame m in the FD-DL, when the HARQ-ACK timing of the DL sub-frames in the FD-UL follows the TDD UL and DL configurations 0 and 6, if the sub-frame m in the FD-UL is the UL sub-frame, the HARQ-ACK timing of the DL sub-frame m in the FD-DL may follow a principle of uniform distribution and the DL sub-frames in the FD-DL may be transmitted in different UL sub-frames. That is, the UE may receive the data of the PDSCH and the control data of the PDCCH or EPDCCH indicating the DL SPS release in the sub-frame (n−k) of the DL carrier, i.e., FD-DL and feed back the HARQ-ACK of the PDSCH in the UL sub-frame n of the UL carrier, i.e., FD-UL. The values of the k may be the figures in the parentheses shown in tables 3 and 4. The configuration number in the table may be the sequence number of the TDD UL and DL configuration of the FD-UL.

TABLE 3

| Configuration | Sub-frame sequence numbern | | | | | | | | | |
|---|---|---|---|---|---|---|---|---|---|---|
| number | 0 | 1 | 2 | 3 | 4 | 5 | 6 | 7 | 8 | 9 |
| 0 | — | — | 6, [5] | [5], [4] | 4 | — | — | 6, [5] | [5], [4] | 4 |
| 1 | — | — | 7, 6 | [6], [5], 4 | — | — | — | 7, 6 | [6], [5], | — |
| | | | | | | | | | 4 | |
| 2 | — | — | 8, 7, 6, | — | — | — | — | 8, 7, 6, | — | — |
| | | | [5], 4 | | | | | [5], 4 | | |
| 3 | — | — | 11, [10], [9], | 6, 5 | 5, 4 | — | — | — | — | — |
| | | | [8], 7, 6 | | | | | | | |
| 4 | — | — | 12, 11, [10], | 7, 6, | — | — | — | — | — | — |
| | | | [9], 8, 7 | 5, 4 | | | | | | |
| 5 | — | — | 13, 12, 11, | — | — | — | — | — | — | — |
| | | | [10], | | | | | | | |
| | | | 9, 8, 7, | | | | | | | |
| | | | 6, 5, 4 | | | | | | | |
| 6 | — | — | [8], 7 | 7, [6] | [6], 5 | — | — | 7 | 7, [6], | — |
| | | | | | | | | | [5] | |

Table 3 Index K: {k₀, k₁, . . . k_{M-1}} of a DL Associate Set of the TDD System

TABLE 4

| Configuration | Sub-frame sequence number n | | | | | | | | | |
|---|---|---|---|---|---|---|---|---|---|---|
| number | 0 | 1 | 2 | 3 | 4 | 5 | 6 | 7 | 8 | 9 |
| 0 | — | — | 6, [5] | [5], [4] | 4 | — | — | 6, [5] | [5], [4] | 4 |
| 1 | — | — | 7, 6 | [6], [5], 4 | — | — | — | 7, 6 | [6], [5], 4 | — |
| 2 | — | — | 8, 7, [5], | — | — | — | — | 8, 7, | — | — |
| | | | 4, 6 | | | | | [5], 4, 6 | | |
| 3 | — | — | [10], [9], [8], | 6,5 | 5, 4 | — | — | | — | — |
| | | | 7, 6, 11 | | | | | | | |
| 4 | — | — | 12, [10], [9], | 6, 5, | — | — | — | — | — | — |
| | | | 8, 7, 11 | 4, 7 | | | | | | |
| 5 | — | — | 13, 12, [10], | — | — | — | — | — | — | — |
| | | | 9, 8, 7, 5, | | | | | | | |
| | | | 4, 11, 6 | | | | | | | |
| 6 | — | — | [8], 7 | 7, [6] | [6], 5 | — | — | 7 | 7, [6], [5] | — |

Table 4 Index K: {k₀, k₁, . . . k_{M-1}} of a DL Associate Set of the TDD System

For instance, it may be assumed that the UE may receive the configuration information of the eNB, the UE may be in a FD mode, the UL and DL sub-frames in the FD-UL may follow a TDD UL and DL configuration 1 and the HARQ-ACK timing of the DL sub-frames in the FD-UL may follow the HARQ-ACK timing of the TDD UL and DL configuration 1. The sub-frames 0 and 1 in the FD-UL may be the DL sub-frames and the HARQ-ACK of the DL sub-frames 0 and 1 in the FD-DL may be transmitted in the UL sub-frame 7. The sub-frame 4 in the FD-UL may be the DL sub-frame and the HARQ-ACK of the DL sub-frame 4 in the FD-DL may be transmitted in the UL sub-frame 8. The sub-frames 5 and 6 in the FD-UL may be the DL sub-frames and the HARQ-ACK of the DL sub-frames 5 and 6 in the FD-DL may be transmitted in the UL sub-frame 2. The sub-frame 9 in the FD-UL may be the DL sub-frame and the HARQ-ACK of the DL sub-frame 9 in the FD-DL may be transmitted in the UL sub-frame 3. The sub-frames 2 and 3 in the FD-UL may be the UL sub-frames and the HARQ-ACK timing of the DL sub-frames 2 and 3 in the FD-DL may follow the HARQ-ACK timing of the sub-frame 4 in the FD-UL. That is, as shown in FIG. 4, the DL sub-frames 2 and 3 in the FD-DL may be transmitted in the UL sub-frame 8, the sub-frames 7 and 8 in the FD-UL may be the UL sub-frames, the HARQ-ACK timing of the DL sub-frames 7 and 8 in the FD-DL may follow the HARQ-ACK timing of the sub-frame 9 in the FD-UL and the DL sub-frames 7 and 8 in the FD-DL may be transmitted in the UL sub-frame 3.

When the number of the UL sub-frames in the FD-UL is 7, 8, 9 or 10, there may be following modes for determining the HARQ-ACK timing.

Mode One:

When the number of the UL sub-frames is 7, 8 or 9, the HARQ-ACK timing of the DL sub-frames in the FD-UL may follow the TDD UL and DL configuration A, A=0, 1, 2, 3, 4, 5 or 6. For instance, it may be determined by the high-layer signaling configuration or protocol that the DL sub-frames in the FD-UL may follow the HARQ-ACK timing of the TDD UL and DL configuration 0.

As for the HARQ-ACK timing of the DL sub-frames in the FD-DL, the HARQ-ACK timing of the TDD UL and DL configuration may be obtained by searching for tables 3 and 4 according to the TDD UL and DL configuration A. That is, the UE may receive the data of the PDSCH and control data of the PDCCH or EPDCCH indicating the DL SPS release in the sub-frame (n−k) of the DL carrier and feed back the HARQ-ACK of the PDSCH in the UL sub-frame n of the UL carrier. The values of the k may be the figures in the parentheses shown in tables 3 and 4. The configuration number in the table may be the sequence number of the TDD UL and DL configuration of the HARQ-ACK timing followed by the FD-UL.

Mode Two:

When the number of the UL sub-frames is 7, 8 or 9, the HARQ-ACK timing of the DL sub-frames in the FD-UL may follow the TDD UL and DL configuration A, A=0, 1, 2, 3, 4, 5 or 6. For instance, it may be determined by the high-layer signaling configuration or protocol that the DL sub-frames in the FD-UL may follow the HARQ-ACK timing of the TDD UL and DL configuration 0.

If the sub-frame n in the FD-UL is the UL sub-frame, the HARQ-ACK of the DL sub-frame (n−4) in the FD-DL may be transmitted in the sub-frame n in the FD-UL. If the sub-frame n in the FD-UL is the DL sub-frame or the special sub-frame, the HARQ-ACK of the DL sub-frame (n−4) in the FD-DL may be transmitted in the UL sub-frame (n+x) in the FD-UL, x>1. The UL sub-frame (n+x) may be the first UL sub-frame behind the sub-frame n. When the distribution of the UL and DL sub-frames in the FD-UL is shown in table 5, the UE may receive the data of the PDSCH and control data of the PDCCH or EPDCCH indicating the DL SPS release in the sub-frame (n−k) of the DL carrier, i.e., FD-DL and feed back the HARQ-ACK of the PDSCH in the UL sub-frame n of the UL carrier, i.e. FD-UL. The values of k may be shown in table 6.

In another example, the HARQ-ACK information of the DL sub-frames in the FD-DL may be equally transmitted in the FD-UL. The UE may receive the data of the PDSCH and control data of the PDCCH or EPDCCH indicating the DL SPS release in the sub-frame (n−k) of the DL carrier, i.e. FD-UL and feed back the HARQ-ACK of the PDSCH in the UL sub-frame n of the UL carrier, i.e. FD-UL. The values of k may be shown in table 7.

TABLE 5

| | DL-UL | | | | | | | | | | |
|---|---|---|---|---|---|---|---|---|---|---|---|
| Number of | conversion | Sequence number of sub-frames in a UL | | | | | | | | | |
| UL sub- | point | and DL conversion period | | | | | | | | | |
| frames | period | 0 | 1 | 2 | 3 | 4 | 5 | 6 | 7 | 8 | 9 |
| 7 | 10 ms | S | U | U | U | U | D | S | U | U | U |
| 7 | 10 ms | D | D | S | U | U | U | U | U | U | U |
| 8 | 10 ms | S | U | U | U | U | S | U | U | U | U |
| 8 | 10 ms | D | S | U | U | U | U | U | U | U | U |
| 9 | 10 ms | S | U | U | U | U | U | U | U | U | U |

TABLE 6

| Number of UL | Sub-frame sequence numbern | | | | | | | | | |
|---|---|---|---|---|---|---|---|---|---|---|
| sub-frames | 0 | 1 | 2 | 3 | 4 | 5 | 6 | 7 | 8 | 9 |
| 7 | — | 5, 4 | 4 | 4 | 4 | — | — | 6, 5, 4 | 4 | 4 |
| 7 | — | — | — | 7, 6, 5, 4 | 4 | 4 | 4 | 4 | 4 | 4 |
| 8 | | 5, 4 | 4 | 4 | 4 | — | 5, 4 | 4 | 4 | 4 |
| 8 | | 6, 5, 4 | 4 | 4 | 4 | 4 | 4 | 4 | 4 | 4 |
| 9 | 5, 4 | 4 | 4 | 4 | 4 | 4 | 4 | 4 | 4 | 4 |

TABLE 7

| Number of UL | Sub-frame sequence numbern | | | | | | | | | |
|---|---|---|---|---|---|---|---|---|---|---|
| sub-frames | 0 | 1 | 2 | 3 | 4 | 5 | 6 | 7 | 8 | 9 |
| 7 | — | 5, 4 | 4 | 4 | 4 | — | — | 6, 5 | 5, 4 | 4 |
| 7 | — | — | — | 7, 6, | 6, 5 | 5, 4 | 4 | 4 | 4 | 4 |
| 8 | | 5, 4 | 4 | 4 | 4 | — | 5, 4 | 4 | 4 | 4 |
| 8 | | 6, 5 | 5, 4 | 4 | 4 | 4 | 4 | 4 | 4 | 4 |
| 9 | 5, 4 | 4 | 4 | 4 | 4 | 4 | 4 | 4 | 4 | 4 |

Mode Three:

When the number of the UL sub-frames is 7, 8 or 9 and the sub-frame n in the FD-UL is the UL sub-frame, the HARQ-ACK of the DL sub-frame (n−4) or special sub-frame (n−4) in the FD-UL may be transmitted in the sub-frame n in the FD-UL. If the sub-frame n in the FD-UL is the DL sub-frame or special sub-frame, the HARQ-ACK of the DL sub-frame (n−4) or special sub-frame (n−4) in the FD-UL may be transmitted in the UL sub-frame (n+x) in the FD-UL, x>1. The sub-frame (n+x) may be the first UL sub-frame behind the sub-frame n in the FD-UL. When the distribution of the UL and DL sub-frames in the FD-UL is shown in table 5, the UE may receive the data of the PDSCH and control data of the PDCCH or EPDCCH indicating the DL SPS release in the sub-frame (n−k) of the UL carrier, i.e. FD-UL and feed back the HARQ-ACK of the PDSCH in the UL sub-frame n of the UL carrier, i.e. FD-UL. The values of k may be shown in table 8.

If the sub-frame n in the FD-UL is the UL sub-frame, the HARQ-ACK of the DL sub-frame (n−4) in the FD-DL may be transmitted in the sub-frame n in the FD-UL. If the sub-frame n in the FD-UL is the DL sub-frame or the special sub-frame, the HARQ-ACK of the DL sub-frame (n−4) in the FD-DL may be transmitted in the UL sub-frame (n+x) in the FD-UL, x>1. The sub-frame (n+x) may be the first UL sub-frame behind the sub-frame n in the FD-UL. When the distribution of the UL and DL sub-frames in the FD-UL is shown in table 5, the UE may receive the data of the PDSCH and control data of the PDCCH or EPDCCH indicating the DL SPS release in the sub-frame (n−k) of the DL carrier, i.e. FD-DL and feed back the HARQ-ACK of the PDSCH in the UL sub-frame n of the UL carrier, i.e. FD-UL. The values of k may be shown in table 6.

In another example, the HARQ-ACK information of the DL sub-frames in the FD-DL may be equally transmitted in the FD-UL. The UE may receive the data of the PDSCH and control data of the PDCCH or EPDCCH indicating the DL SPS release in the sub-frame (n−k) of the DL carrier, i.e. FD-UL and feed back the HARQ-ACK of the PDSCH in the UL sub-frame n of the UL carrier, i.e. FD-UL. The values of k may be shown in table 7.

TABLE 8

| Number of UL | Sub-frame sequence numbern | | | | | | | | | |
|---|---|---|---|---|---|---|---|---|---|---|
| sub-frames | 0 | 1 | 2 | 3 | 4 | 5 | 6 | 7 | 8 | 9 |
| 7 | — | 5 | | 4 | | | | | | 4 |
| 7 | — | — | — | | 4 | 4 | 4 | | | |
| 8 | | | | | 4 | | | | | 4 |
| 8 | | | | | 4 | 4 | | | | |
| 9 | | | | | 4 | | | | | |

When the number of the UL sub-frames is 10, the HARQ-ACK timing of the FD-DL may follow an FDD HARQ-ACK timing.

When the DL sub-frames or special sub-frames in the FD-DL carrier and the UL sub-frames in the FD-UL carrier may be distributed according to a specific period of Tms, for instance, when the DL sub-frames are distributed in the period of T=40 ms, the method for determining the HARQ-ACK timing may be as follows.

If the sub-frame n in the FD-UL is the UL sub-frame and the sub-frame (n−4) in the FD-UL is the DL sub-frame or special sub-frame, the HARQ-ACK timing of the DL sub-frame (n−4) or special sub-frame (n−4) in the FD-UL may follow the FDD HARQ-ACK timing. If the sub-frame (n−4) in the FD-UL is the DL sub-frame or special sub-frame, the sub-frame n in the FD-UL may be the DL sub-frame or special sub-frame. The HARQ-ACK of the DL sub-frame (n−4) or the special sub-frame (n−4) in the FD-UL may be transmitted in the UL sub-frame (n+x) in the FD-UL, x>1. The sub-frame (n+x) may be the first UL sub-frame behind the sub-frame n in the FD-UL.

As for the DL sub-frame m in the FD-UL, if the sub-frame m in the FD-UL is the DL sub-frame or special sub-frame, the HARQ-ACK timing of the DL sub-frame m in the FD-UL may follow the HARQ-ACK timing of the DL sub-frame m or special sub-frame m in the FD-UL. As shown in FIG. 5, if the sub-frame m in the FD-UL is the UL sub-frame, the HARQ-ACK timing of the DL sub-frame m in the FD-DL may follow the HARQ-ACK timing of the first DL sub-frame behind the sub-frame m in the FD-UL. In another example, if the sub-frame n in the FD-UL is the UL sub-frame and the sub-frame (n−4) in the FD-UL is the DL sub-frame, the HARQ-ACK information of the DL sub-frame (n−4) in the FD-DL may be transmitted in the sub-frame n in the FD-UL. If the sub-frame (n−4) in the FD-DL is the DL sub-frame, the sub-frame n in the FD-UL is the DL sub-frame or special sub-frame, the HARQ-ACK of the DL sub-frame (n−4) in the FD-DL may be transmitted in the UL sub-frame (n+x) in the FD-UL, x>1. As shown in FIG. 6, the sub-frame (n+x) may be the first UL sub-frame behind the sub-frame n in the FD-UL.

In another example, the PDSCH HARQ timing may be defined as the period of 10 ms. It may be ensured that the position for feeding back the HARQ-ACK in each 10 ms frame may be fixed as the UL sub-frame according to a sub-frame pattern in the FD-UL configured in the period of T=40 ms. The TDD UL and DL configuration may be determined according to the position of the sub-frame fixed as the UL sub-frame in the 10 ms frame. The PDSCH HARQ timing of the DL sub-frames in the FD-UL may be obtained taking the TDD UL and DL configuration as a DL reference UL and DL configuration. The PDSCH HARQ timing of each DL sub-frame in the FD-DL may be obtained according to the TDD UL and DL configuration and tables 3, 4 and 6.

### Embodiment Two

In this embodiment, the UL or DL direction of some sub-frames in the FD-UL carrier may be changed. The sub-frames of the FD-UL carrier may be changed to DL sub-frames or special sub-frames, while all sub-frames in the FD-DL may be configured as the DL sub-frames.

PDSCH scheduling and transmission and a soft buffer may have following processing modes.

Mode one: as for a same UE, DL sub-frames in the FD-DL and DL sub-frames or special sub-frames in the FD-UL may be simultaneously used.

The PDSCH scheduling of the FD-DL and FD-UL may have following methods.

Method One:

One PDSCH scheduling method may be that the DL of the FD-DL and the DL of the FD-UL may be taken as two cells for processing. A DL sub-frame in the FD-DL may be scheduled by another DL sub-frame in the FD-DL. A DL sub-frame or special sub-frame in the FD-UL may be cross-carrier scheduled by the DL sub-frame in the FD-DL. For instance, a DL sub-frame n or special sub-frame n in the FD-UL may be scheduled by a DL sub-frame n in the FD-DL. Blind detection of the scheduling of the DL sub-frames in the FD-DL may be performed for all DL sub-frames in the FD-DL. Blind detection of the cross-carrier scheduling of the DL sub-frames or special sub-frames in the FD-DL may be performed when the FD-UL are the DL sub-frames and the FD-UL are the DL sub-frames or special sub-frames. The scheduling of the UL sub-frames in the FD-UL and the scheduling of the DL sub-frames in the FD-DL may be the scheduling of the same cell. The scheduling of the UL sub-frames in the FD-UL and the scheduling of the DL sub-frames in the FD-DL may use a same carrier indicator field (CIF). In a same (E)PDCCH searching space, if number of bits for scheduling (E)PDCCH format 0 of a UL sub-frame in the FD-UL is different from number of bits for scheduling (E)PDCCH format 1A of a DL sub-frame in the FD-DL, number 0 may be added to make the number of the bits for scheduling the (E)PDCCH format 0 of the UL sub-frame in the FD-UL equal to the number of the bits for scheduling the (E)PDCCH format 1A of the DL sub-frame in the FD-DL. The scheduling of the UL sub-frame in the FD-UL and the scheduling of the DL sub-frame in the FD-UL may not be the scheduling of the same cell. That is, in the same (E)PDCCH searching space, if the number of the bits for scheduling the (E)PDCCH format 0 of the UL sub-frame in the FD-UL is different from the number of the bits for scheduling the (E)PDCCH format 1A of the DL sub-frame in the FD-DL, number 0 may not be needed to be added to make the number of the bits for scheduling the (E)PDCCH format 0 of the UL sub-frame in the FD-UL equal to the number of the bits for scheduling the (E)PDCCH format 1A of the DL sub-frame in the FD-DL. The UE may only perform the blind detection for the (E)PDCCH transmitted in the DL sub-frame in the FD-DL to receive the PDSCH of the DL sub-frames in the FD-UL and FD-DL. Since the DL sub-frame in the FD-DL schedules the DL sub-frame in the FD-DL and schedules the DL sub-frame or special sub-frame in the FD-UL, the scheduling may need to be distinguished. One distinguishing method may be indicating the scheduling with information in the CIF. That is, The FD-DL and FD-UL of the FD cell may be taken as two member cells for processing and different CIFs may be allocated to the FD-DL and FD-UL. If the FD cell corresponds to the Pcell of the UE, the FD-DL may still correspond to CIF=0, while other CIF values may be allocated to the FD-UL.

Method Two:

Another PDSCH scheduling method may be that the DL of the FD-DL and the DL of the FD-UL may be taken as two cells for processing. A DL sub-frame in the FD-DL may be scheduled by another DL sub-frame in the FD-DL. A DL sub-frame or special sub-frame in the FD-UL may be scheduled by another DL sub-frame or special sub-frame in the FD-UL. Blind detection of the scheduling of the DL sub-frame or special sub-frame in the FD-UL may be performed for the DL sub-frame or special sub-frame in the FD-UL. Blind detection of the (E)PDCCH transmitted in the DL sub-frame in the FD-DL may be performed by the UE. Furthermore, blind detection of the (E)PDCCH transmitted in the DL sub-frame or special sub-frame in the FD-UL may be performed by the UE. The UL sub-frame in the FD-UL may be scheduled by the FD-DL and the scheduling of the UL sub-frames in the FD-UL and the scheduling of the DL sub-frames in the FD-DL may be the scheduling of the same cell. In a same (E)PDCCH searching space, if number of bits for scheduling (E)PDCCH format 0 of a UL sub-frame in the FD-UL is different from number of bits for scheduling (E)PDCCH format 1A of DL sub-frame in the FD-DL, number 0 may be added to make the number of the bits for scheduling the (E)PDCCH format 0 of the UL sub-frame in the FD-UL equal to the number of the bits for scheduling the (E)PDCCH format 1A of the DL sub-frame in the FD-DL. The scheduling of the UL sub-frame in the FD-UL and the scheduling of the DL sub-frame in the FD-UL may not be the scheduling of the same cell. That is, in the same (E)PDCCH searching space, if the number of the bits for scheduling the (E)PDCCH format 0 of the UL sub-frame in the FD-UL is different from the number of the bits for scheduling the (E)PDCCH format 1A of the DL sub-frame in the FD-DL, number 0 may not be needed to be added to make the number of the bits for scheduling the (E)PDCCH format 0 of the UL sub-frame in the FD-UL equal to the number of the bits for scheduling the (E)PDCCH format 1A of the DL sub-frame in the FD-DL.

Method Three:

When DL sub-frames of the FD-DL and FD-UL are cross-carrier scheduled by another cell, the FD-DL and the FD-UL may be taken as two cells for processing. That is, different CIF values may be allocated to the FD-DL and FD-UL. One CIF value may represent that the sub-frame in the FD-DL may be scheduled. A different CIF value may represent that the sub-frame in the FD-UL may be scheduled. The scheduling of the UL sub-frames in the FD-UL and the scheduling of the DL sub-frames in the FD-DL may be the scheduling of the same cell. The scheduling of the UL sub-frames in the FD-UL and the scheduling of the DL sub-frames in the FD-DL may use a same carrier indicator field (CIF). In a same (E)PDCCH searching space, if number of bits for scheduling (E)PDCCH format 0 of a UL sub-frame in the FD-UL is different from number of bits for scheduling (E)PDCCH format 1A of DL sub-frame in the FD-DL, number 0 may be added to make the number of the bits for scheduling the (E)PDCCH format 0 of the UL sub-frame in the FD-UL equal to the number of the bits for scheduling the (E)PDCCH format 1A of the DL sub-frame in the FD-DL. The scheduling of the UL sub-frame in the FD-UL and the scheduling of the DL sub-frame in the FD-UL may not be the scheduling of the same cell. That is, in the same (E)PDCCH searching space, if the number of the bits for scheduling the (E)PDCCH format 0 of the UL sub-frame in the FD-UL is different from the number of the bits for scheduling the (E)PDCCH format 1A of the DL sub-frame in the FD-DL, number 0 may not be needed to be added to make the number of the bits for scheduling the (E)PDCCH format 0 of the UL sub-frame in the FD-UL equal to the number of the bits for scheduling the (E)PDCCH format 1A of the DL sub-frame in the FD-DL.

Method Four:

When DL sub-frames of the FD-DL and FD-UL are cross-carrier scheduled by another cell, the DL of the FD-DL and the DL of the FD-UL may be taken as two cells for processing. That is, different CIF values may be allocated to the DL of the FD-DL and the DL of the FD-UL. One CIF value may represent that the sub-frame in the FD-DL may be scheduled. A different CIF value may represent that the DL sub-frame or the special sub-frame in the FD-UL may be scheduled. The UL sub-frames in the FD-UL and the DL sub-frames in the FD-DL may be cross-carrier scheduled by a cell. The scheduling of the UL sub-frames in the FD-UL and the scheduling of the DL sub-frames in the FD-DL may be the scheduling of the same cell. The scheduling of the UL sub-frames in the FD-UL and the scheduling of the DL sub-frames in the FD-DL may use a same carrier indicator field (CIF). In a same (E)PDCCH searching space, if number of bits for scheduling (E)PDCCH format 0 of a UL sub-frame in the FD-UL is different from number of bits for scheduling (E)PDCCH format 1A of DL sub-frame in the FD-DL, number 0 may be added to make the number of the bits for scheduling the (E)PDCCH format 0 of the UL sub-frame in the FD-UL equal to the number of the bits for scheduling the (E)PDCCH format 1A of the DL sub-frame in the FD-DL. The scheduling of the UL sub-frame in the FD-UL and the scheduling of the DL sub-frame in the FD-UL may not be the scheduling of the same cell. That is, in the same (E)PDCCH searching space, if the number of the bits for scheduling the (E)PDCCH format 0 of the UL sub-frame in the FD-UL is different from the number of the bits for scheduling the (E)PDCCH format 1A of the DL sub-frame in the FD-DL, number 0 may not be needed to be added to make the number of the bits for scheduling the (E)PDCCH format 0 of the UL sub-frame in the FD-UL equal to the number of the bits for scheduling the (E)PDCCH format 1A of the DL sub-frame in the FD-DL. The DL sub-frame in the FD-UL may be cross-carrier scheduled by another cell or the DL sub-frame in the FD-UL may be self-scheduled.

Method Five:

A PDSCH scheduling method may be that the FD-DL and FD-UL may be taken as one cell for processing. One bit may be added to DL assignment. One bit may be reserved or bits in the conventional domain in the DL assignment may be re-explained to indicate whether PDSCH scheduled by the current DL assignment is the PDSCH in the FD-DL or the PDSCH in the FD-UL.

The processing of the soft buffer of the UE may include: taking the FD-UL and FD-DL as cells in different configurations in the CA. HARQ process number of each cell may be independently determined and may be respectively determined according to a DL HARQ-ACK timing of each cell or a reference DL HARQ-ACK timing. In another example, the FD-UL and FD-DL may be taken as a same virtual cell for processing. The maximum HARQ process number of the virtual cell may be determined according to the HARQ ACK timing.

Method two: as for the same UE, at the same moment, DL reception only may be performed in one of the FD-DL and FD-UL.

A DL sub-frame in the FD-DL may be scheduled by another DL sub-frame in the FD-DL and a DL sub-frame in the FD-UL may be scheduled by another DL sub-frame in the FD-UL. At the same moment, blind detection of the (E)PDCCH transmitted in only one DL sub-frame in the FD-DL and FD-UL may be performed by the UE. The blind detection of the scheduling of the DL sub-frame in the FD-UL may only be performed for the DL sub-frame in the FD-UL. In each sub-frame, whether the blind detection is performed by the UE for the (E)PDCCH transmitted in the DL sub-frame in the FD-DL or on the (E)PDCCH transmitted in the DL sub-frame in the FD-UL is determined via indication information received by the UE from the eNB, for instance, may be indicated ma bitmap mode via the high-layer signaling. A specific indication mode may be indicating via a bitmap configured utilizing the high-layer signaling. The bitmap may include L bit information and equal to a sub-frame configuration period. The value of each bit of the bitmap may indicate whether the sub-frame belongs to the FD-DL or the FD-UL. Bit “0” may indicate that the sub-frame may belong to the FD-DL and bit “1” may indicate that the sub-frame may belong to the FD-UL. In another example, the FD-UL may be indicated by one bitmap and the FD-UL may be indicated by another bitmap. Each bitmap may include L bit information and equal to a sub-frame configuration period. The value of each bit of the bitmap may indicate whether the sub-frame may be scheduled or may not be scheduled. Bit “0” may indicate that the sub-frame can be scheduled, while bit “1” may indicate that the sub-frame cannot be scheduled. In another example, if all sub-frames of the FD-DL and FD-UL are the DL sub-frames or special sub-frames, one bit information may indicate whether the UE detects the DL sub-frames in the FD-DL or detects the DL sub-frames or special sub-frames in the FD-UL.

When the FD-DL and FD-UL are cross-carrier scheduled by another cell, the FD-DL and FD-UL may be taken as one cell for processing. As for the (E) PDCCH received by each sub-frame, the scheduled PDSCH may indicate whether the FD-DL or FD-UL may be scheduled in this sub-frame via the high-layer signaling. The scheduled PDSCH may indicate via the high-layer signaling in a bitmap mode. A specific indication mode may be indicating via a bitmap configured utilizing the high-layer signaling. The bitmap may include L bit information and equal to a sub-frame configuration period. The value of each bit of the bitmap may indicate whether the sub-frame belongs to the FD-DL or the FD-UL. Bit “0” may indicate that the sub-frame may belong to the FD-DL and bit “1” may indicate that the sub-frame may belong to the FD-UL. In another example, the FD-UL may be indicated by one bitmap and the FD-UL may be indicated by another bitmap. Each bitmap may include L bit information and equal to a sub-frame configuration period. The value of each bit of the bitmap may indicate whether the sub-frame may be scheduled or may not be scheduled. Bit “0” may indicate that the sub-frame can be scheduled, while bit “1” may indicate that the sub-frame cannot be scheduled. In another example, if all sub-frames of the FD-DL and FD-UL are the DL sub-frames, one bit information may indicate whether the UE detects the DL sub-frames in the FD-DL or detects the DL sub-frames or special sub-frames in the FD-UL.

For instance, it may be assumed that the FD-DL and FD-UL may adopt the same HARQ timing of the PDSCH and DL sub-frames in the FD-UL may be a sub-set of DL sub-frames in the FD-DL. Therefore, total HARQ process number transmitted on the PDSCH of two carriers may be determined according to all DL sub-frames of the FD-DL. In another example, the total HARQ process number transmitted by the UE on the PDSCH of the two carriers may be determined according to a configured set of sub-frames, which may transmit DL data, in the FD-DL and FD-UL.

The HARQ-ACK mapping may be processed according one cell. The sorting may be performed according to sequence of sub-frames in the FD-DL and FD-UL. In another example, the HARQ-ACK mapping may be processed according to two cells. Sub-frames in the FD-DL may be sorted first and sub-frames in the FD-UL may be sorted then.

The processing of the soft buffer of the UE may include: taking the FD-UL and FD-DL as a same virtual cell for processing. The maximum HARQ process number of the virtual cell may be determined according to the HARQ-ACK timing of all DL sub-frames of the FD-DL. In another example, the total HARQ process number transmitted by the UE on the PDSCH of the two carriers may be determined according to a configured union set of sub-frames, which may transmit the DL data, in the FD-DL and FD-UL.

Method three: as for a same UE, the UE may keep monitoring control information, such as system information and paging information on the FD-DL and receive DL data except for the control information on one carrier in the FD-DL or FD-UL. If the FD cell is a Scell of the UE, the control information such as the system information and the paging information may not need to be monitored in the FD cell. Then, the UE may receive the DL data on one of the FD-DL or FD-UL.

Whether the UE transmits the data of the PDSCH and control data of the PDCCH or EPDCCH indicating the DL SPS release in a DL sub-frame in the FD-DL or whether the UE transmits the data of the PDSCH or the control data of the PDCCH or EPDCCH indicating the DL SPS release in a DL sub-frame in the FD-UL may be determined according to the high-layer signaling received by the UE from the eNB.

If the UE only transmits the data in the FD-DL, the DL sub-frame in the FD-DL may be scheduled by the DL sub-frame in the FD-DL. Blind detection of the (E)PDCCH transmitted in the DL sub-frame in the FD-DL may be performed by the UE. If the UE only transmits the data in the FD-UL, the blind detection of the (E)PDCCH of an exclusive searching space of the UE may be performed by the UE in the corresponding DL sub-frame in the FD-DL. In another example, the blind detection of the (E)PDCCH of the exclusive searching space of the UE may be performed by the UE in the corresponding DL sub-frame of the FD-UL. The blind detection of the scheduling of the DL sub-frame in the FD-UL may only be performed for the DL sub-frame in the FD-UL. At the same time, the blind detection may be performed by the UE for the PDCCH of a cell public searching space transmitted in the DL sub-frame in the FD-DL to obtain the system information and paging information, etc.

If the FDD is the Scell and the UE only transmits the data in the FD-DL, the DL sub-frame in the FD-DL may only be scheduled by the DL sub-frame in the FD-DL. The blind detection of the (E)PDCCH transmitted in the DL sub-frame in the FD-DL may be performed by the UE. If the UE only transmits the user data in the FD-UL, the blind detection of the (E)PDCCH of the exclusive searching space of the UE may be performed by the UE in the corresponding DL sub-frame of the FD-DL. In another example, the blind detection of the (E)PDCCH of the exclusive searching space of the UE may be performed by the UE in the corresponding DL sub-frame or special sub-frame in the FD-UL. When the FD-DL or FD-UL is cross-carrier scheduled by another cell, the FDD cell may be taken as a same cell for processing. If the UE only transmits the data in the FD-DL, the sub-frame in the FD-DL may be cross-carrier scheduled. If the UE only transmits the data in the FD-UL, the DL sub-frame or special sub-frame in the FD-UL may be cross-carrier scheduled.

The processing of the soft buffer of the UE may be that if the UE only transmits the data in the FD-DL, the maximum HARQ process number may be determined according to the HARQ-ACK timing of the PDSCH of the FD-DL. If the UE only transmits the data in the DL sub-frame or special sub-frame in the FD-UL, the maximum HARQ process number may be determined according to the HARQ-ACK timing of the PDSCH of the FD-UL.

### Embodiment Three

In this embodiment, the UL or DL direction of some sub-frames in the FD-UL carrier may be changed. The sub-frames of the FD-UL carrier may be changed to DL sub-frames or special sub-frames, while all sub-frames in the FD-DL may be configured as the DL sub-frames.

The UE may obtain sub-frame configuration information of the FD-UL carrier via receiving dynamic indication information of the eNB. The sub-frame configuration information may include: position of sub-frames, the duplex direction of which may be changed, on the FD-DL carrier. One possible mode may be that the eNB may dynamically indicate sub-frame configuration information of the FD-UL carrier via the signaling borne by the (E)PDCCH. The (E)PDCCH may be transmitted in any sub-frame in the FD-DL. In another example, the (E)PDCCH not only may be transmitted in any sub-frame in the FD-DL, but also may be transmitted in the fixed DL sub-frame or special sub-frame in the FD-UL. For instance, if the sub-frame configuration of the FD-UL may be conversed in the current seven kinds of TDD UL and DL configurations, sub-frames 0, 1, 5 and 6 may be fixed DL sub-frames or special sub-frames.

In a situation that the sub-frame configuration information of the FD-UL carrier is a dynamic indication, a DL HARQ-ACK timing of the FD-DL and FD-UL, a scheduling method of the PDSCH and a processing method of a soft buffer may be the same as those in embodiment one and embodiment two. The TDD UL and DL configuration indicating the FD-UL in the embodiment one and embodiment two may be replaced by a reference TDD UL and DL configuration. The reference TDD UL and DL configuration may be the DL HARQ-ACK timing, which may need to be followed by the FD-UL. The UE may obtain the reference TDD UL and DL configuration via the configuration of the high-layer signaling.

### Embodiment Four

In this embodiment, the duplex direction of some sub-frames of the FD-DL carrier may be changed. The sub-frames of the FD-DL carrier may be changed to UL sub-frames, while all sub-frames of the FD-UL may be configured as the UL sub-frames.

One PDSCH scheduling method may be that the DL sub-frame in the FD-DL may be scheduled by the DL sub-frame in the FD-DL. The blind detection of the scheduling of the DL sub-frame in the FD-DL may only be performed for the DL sub-frame in the FD-DL. Blind detection may only be performed by the UE for the (E)PDCCH transmitted in the DL sub-frame in the FD-DL to receive the PDSCH of the DL sub-frame in the FD-DL.

The HARQ-ACK timing of the DL sub-frame in the FD-DL may follow the FDD timing and may be transmitted in the UL sub-frame in the FD-UL.

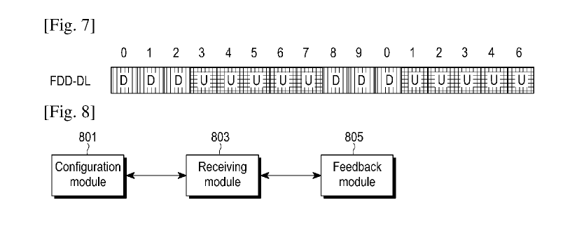

The processing of the soft buffer of the UE may be that the HARQ process number of the cell may be determined according to the FDD HARQ-ACK timing. That is, the HARQ process number is 8. In another example, the number of the UL sub-frames in a process period may be subtracted from the HARQ process number. For instance, as shown in FIG. 7, if five of the eight sub-frames in a process period are changed to the UL sub-frames, the HARQ process number may be three.

### Embodiment 5

In accordance with the above method, the present application may disclose a terminal device. As shown in FIG. 8, this terminal may be used for implementing multiple sub-frames scheduling of the PDSCH.

The terminal device may include:

a configuration module 801, configured to receive configuration information from an eNB. With the configuration information, the UE may work in a FD mode.

The terminal device may further include a receiving module 803, configured to receive data of a PDCCH and control data of a PDCCH or EPDCCH indicating DL SPS release according to a scheduling mode of the configured FD mode.

The terminal device may further include a feedback module 805, configured to feed back HARQ-ACK information according to a corresponding HARQ-ACK timing.

Meanwhile, although the configuration module 801 and the receiving module 803 are illustrated as separated components in FIG. 8, the configuration module 801 and the receiving module 803 may be implemented as one component. Further, the configuration module 801, the receiving module 803 and the feedback module 805 may be implemented as one component.

The foregoing only describes examples of the present disclosure. The protection scope of the present disclosure, however, is not limited to the above description. Any change or substitution, easily occurring to those skilled in the art, should be covered by the protection scope of the present disclosure.

1. A method for communicating data on physical downlink shared channel (PDSCH), comprising:
receiving, by a user equipment (UE), configuration information, with which the UE works in a flexible duplex (FD) mode;
receiving, by the UE, data of a PDSCH and control data of a physical downlink control channel (PDCCH) or enhanced physical downlink control channel (EPDCCH) indicating downlink (DL) semi-persistent scheduling (SPS) release according to a scheduling mode of the FD mode; and
feeding back, by the UE, hybrid automatic repeat request-acknowledge (HARQ-ACK) information according to a corresponding HARQ-ACK timing.

2. The method according to claim 1, wherein
the FD mode comprises that in a period, some sub-frames of flexible duplex-uplink (FD-UL) are DL sub-frames or special sub-frames and all sub-frames of FD-DL are DL sub-frames;
the FD-DL and FD-UL are a pair of frequency division duplexing (FDD) carriers, the FD-DL is a carrier for performing DL transmission by a backward FDD UE and the FD-UL is a carrier for performing UL transmission by the backward FDD UE.

3. The method according to claim 2, wherein
the period is 10 ms, in one period, UL and DL sub-frames in the FD-UL follow one of conventional seven kinds of TDD UL and DL configurations, or
in one period, the FD-UL comprises: 7, 8, 9 or 10 UL sub-frames.

4. The method according to claim 3, wherein
when the UL and DL sub-frames in the FD-UL follow a TDD UL and DL configuration A in the convention seven kinds of TDD UL and DL configurations, a HARQ-ACK timing of DL sub-frames in the FD-UL follows the TDD UL and DL configuration A; wherein the feeding back HARQ-ACK information according to a corresponding HARQ-ACK timing comprises:
transmitting HARQ-ACK information of the DL sub-frames in the FD-UL in corresponding UL sub-frames in the FD-UL.

5. The method according to claim 4, wherein
as for a DL sub-frame m in the FD-DL, if a sub-frame m in the FD-UL is the DL sub-frame or special sub-frame, the DL sub-frame m in the FD-DL follows the HARQ-ACK timing of the TDD UL and DL configuration A and the HARQ-ACK timing comprises: if the UE receives the data of the PDSCH and control data of the PDCCH or EPDCCH indicating the DL SPS release in a sub-frame (n−k) in the FD-DL, the feeding back HARQ-ACK information according to a corresponding HARQ-ACK timing comprises: feeding back the HARQ-ACK information on a UL sub-frame n of the FD-UL; wherein values of k are figures without parentheses as shown in tables 9 and 10; a configuration sequence number in the tables 9 and 10 is a sequence number of a TDD UL and DL configuration of the FD-UL;
as for the DL sub-frame m in the FD-DL, when the HARQ-ACK timing of the DL sub-frames in the FD-UL follows TDD UL and DL configurations 1 to 5, if the sub-frame m in the FD-UL is a UL sub-frame, the HARQ-ACK timing of the DL sub-frame m in the FD-DL follows the HARQ-ACK timing of a first DL sub-frame behind the sub-frame m in the FD-UL, the HARQ-ACK timing comprises: if the UE receives the data of the PDSCH and the control data of the PDCCH or EPDCCH indicating the DL SPS release in the sub-frame (n−k) in the FD-DL, the feeding back HARQ-ACK information according to a corresponding HARQ-ACK timing comprises: feeding back the corresponding HARQ-ACK information in the UL sub-frame n of the FD-UL; wherein the values of k are the figures in the parentheses as shown in tables 9 and 10;
as for the DL sub-frame m in the FD-DL, when the HARQ-ACK timing of the DL sub-frames in the FD-UL follows TDD UL and DL configurations 0 and 6, if the sub-frame m in the FD-DL is the UL sub-frame, the HARQ-ACK timing of the DL sub-frame m in the FD-DL follows a principle of uniform distribution, the DL sub-frames in the FD-DL are transmitted in different UL sub-frames and the UE receives the data of the PDSCH and the control data of the PDCCH or EPDCCH indicating the DL SPS release in the sub-frame (n−k) of the FD-DL, the feeding back HARQ-ACK information according to a corresponding HARQ-ACK timing comprises: feeding back the HARQ-ACK information in the UL sub-frame n in the FD-UL; wherein the values of k are the values in the parentheses as shown in tables 9 and 10;
TABLE 9

| Configuration | Sub-frame sequence number n | | | | | | | | | |
|---|---|---|---|---|---|---|---|---|---|---|
| number | 0 | 1 | 2 | 3 | 4 | 5 | 6 | 7 | 8 | 9 |
| 0 | — | — | 6, [5] | [5], [4] | 4 | — | — | 6, [5] | [5], [4] | 4 |
| 1 | — | — | 7, 6 | [6], [5], 4 | — | — | — | 7, 6 | [6], [5], 4 | — |
| 2 | — | — | 8, 7, 6, [5], | — | — | — | — | 8, 7, 6, [5], | — | — |
| | | | 4 | | | | | 4 | | |
| 3 | — | — | 11, [10], [9], | 6, 5 | 5, 4 | — | — | — | — | — |
| | | | [8], 7, 6 | | | | | | | |
| 4 | — | — | 12, 11, [10], | 7, 6, 5, 4 | — | — | — | — | — | — |
| | | | [9], 8, 7 | | | | | | | |
| 5 | — | — | 13, 12, 11, | — | — | — | — | — | — | — |
| | | | [10], 9, 8, | | | | | | | |
| | | | 7, 6, 5, 4 | | | | | | | |
| 6 | — | — | [8], 7 | 7, [6] | [6], 5 | — | — | 7 | 7, [6], [5] | — |

TABLE 10

| Configuration | Sub-frame sequence number n | | | | | | | | | |
|---|---|---|---|---|---|---|---|---|---|---|
| number | 0 | 1 | 2 | 3 | 4 | 5 | 6 | 7 | 8 | 9 |
| 0 | — | — | 6, [5] | [5], [4] | 4 | — | — | 6,[5] | [5], [4] | 4 |
| 1 | — | — | 7, 6 | [6], [5], 4 | — | — | — | 7, 6 | [6], [5], 4 | — |
| 2 | — | — | 8, 7, [5], | — | — | — | — | 8, 7, | — | — |
| | | | 4, 6 | | | | | [5], 4, 6 | | |
| 3 | — | — | [10], [9], [8], | 6, 5 | 5, 4 | — | — | — | — | — |
| | | | 7, 6, 11 | | | | | | | |
| 4 | — | — | 12, [10], [9], | 6, 5, | — | — | — | — | — | — |
| | | | 8, 7, 11 | 4, 7 | | | | | | |
| 5 | — | — | 13, 12, [10], | — | — | — | — | — | — | — |
| | | | 9, 8, 7, | | | | | | | |
| | | | 5, 4, 11, 6 | | | | | | | |
| 6 | — | — | [8], 7 | 7, [6] | [6], 5 | — | — | 7 | 7, [6], [5] | — |

6. The method according to claim 2, wherein
the period is in other length except for 10 ms, in one period, UL and DL sub-frames in the FD-UL are indicated by a bitmap configured by high-layer signaling.

7. The method according to claim 2, wherein as for a same UE, a DL sub-frame in the FD-DL and a DL sub-frame or special sub-frame in the FD-UL are used simultaneously.

8. The method according to claim 7, wherein the scheduling mode in the receiving data of a PDSCH and control data a PDCCH or EPDCCH indicating DL SPS release according to a scheduling mode of the FD mode comprises:
DL transmission of the FD-DL and DL transmission of the FD-UL are taken as two cells for processing, a DL sub-frame in the FD-DL is scheduled by another DL sub-frame in the FD-DL, a DL sub-frame or special sub-frame in the FD-UL is cross-carrier scheduled by a DL sub-frame in the FD-DL; blind detection of scheduling of DL sub-frames in the FD-DL is performed for all DL sub-frames in the FD-DL; blind detection of cross-carrier scheduling of DL sub-frames or special sub-frames in the FD-UL is performed for a sub-frame, which is the DL sub-frame in the FD-DL and is the DL sub-frame or special sub-frame in the FD-UL; or
the DL transmission of the FD-DL and the DL transmission of the FD-UL are taken as two cells for processing, a DL sub-frame in the FD-DL is scheduled by another DL sub-frame in the FD-DL, a DL sub-frame or special sub-frame in the FD-UL is cross-carrier scheduled by a DL sub-frame or special sub-frame in the FD-DL; the blind detection of scheduling of a DL sub-frame or special sub-frame in the FD-UL is performed for a DL sub-frame or special sub-frame in the FD-UL; the blind detection is performed by the UE for the PDCCH or EPDCCH transmitted in the DL sub-frame in the FD-DL, the blind detection is performed by the UE for the PDCCH or EPDCCH transmitted in a DL sub-frame or special sub-frame in the FD-UL, a UL sub-frame in the FD-UL is scheduled by the FD-DL and scheduling of a UL sub-frame in the FD-UL and scheduling of a DL sub-frame in the FD-DL is scheduling of a same cell; or
DL sub-frames of the FD-DL and FD-UL are cross-carrier scheduled by another cell, and the FD-DL and FD-UL are taken as two cells for processing; or
the DL sub-frames of the FD-DL and FD-UL are cross-carrier scheduled by different cells and the DL transmission of the FD-DL and DL transmission of the FD-UL are taken as two cells for processing; or
the FD-DL and FD-UL are taken as one cell for processing, one bit is added to DL scheduling assignment, one bit may be reserved or bits in a conventional domain in the DL scheduling assignment is re-explained to indicate that the PDSCH in the FD-DL or the PDSCH in the FD-UL is respectively scheduled by the DL scheduling assignment.

9. The method according to claim 8, further comprising:
taking, by a soft buffer of the UE, the FD-UL and FD-DL as cells with different configurations in carrier aggregation (CA), independently determining a HARQ process number of each cell according to a DL HARQ-ACK timing or reference DL HARQ-ACK timing of the each cell; or taking the FD-UL and FD-DL as one virtual cell for processing and determining the maximum HARQ process number of the virtual cell according to the HARQ-ACK timing.

10. The method according to claim 2, wherein
as for a same UE, at a same moment, DL reception is only performed in one of the FD-DL and FD-UL.

11. The method according to claim 10, wherein the scheduling mode in the receiving data of a PDSCH and control data a PDCCH or EPDCCH indicating DL SPS release according to a scheduling mode of the FD mode comprises:
a DL sub-frame in the FD-DL is scheduled by another DL sub-frame in the FD-DL, a DL sub-frame in the FD-UL is scheduled by another DL sub-frame in the FD-UL, blind detection is performed by the UE for the PDCCH or EPDCCH transmitted in a DL sub-frame in one of the FD-DL and FD-UL and the blind detection of the scheduling of a DL sub-frame in the FD-UL is only performed by the UE for the DL sub-frame in the FD-UL; or
when the FD-DL and FD-UL are cross-carrier scheduled by another cell, the FD-DL and FD-UL are taken as one cell for processing and as for the PDCCH or EPDCCH received in each sub-frame, a scheduled PDSCH indicates whether the FD-DL or FD-UL is scheduled in the each sub-frame according to high-layer signaling in a bitmap.

12. The method according to claim 11, further comprising:
taking, by a soft buffer of the UE, the FD-UL and FD-DL as one virtual cell for processing, determining the maximum HARQ process number of the virtual cell according to a HARQ-ACK timing of all DL sub-frames in the FD-DL, or determining the maximum HARQ process number of the virtual cell according to total HARQ process number transmitted by the UE on the PDSCH of the two carriers and a configured union set of sub-frames for transmitting DL data in the FD-DL and FD-UL.

13. The method according to claim 2, further comprising:
as for a same UE, monitoring, by the UE, control information on the FD-DL and receiving DL data except for the control information on the FD-DL or FD-UL;
determining, by the UE, whether the data of the PDSCH and the control data of the PDCCH or EPDCCH indicating the DL SPS release is transmitted in a DL sub-frame in the FD-DL or whether the data of the PDSCH and the control data of the PDCCH or EPDCCH indicating the DL SPS release is transmitted in a DL sub-frame in the FD-UL.

14. The method according to claim 13, further comprising:
determining, by a soft buffer of the UE, the maximum HARQ process number according to a HARQ-ACK timing of the PDSCH of the FD-DL if the UE only transmits data in the FD-DL;
determining, by the soft buffer of the UE, the maximum HARQ process number according to the HARQ-ACK timing of the PDSCH of the FD-UL if the UE only transmits the data in a DL sub-frame or special sub-frame in the FD-UL.

15. A user device, comprising:
a configuration module, a receiving module and a feedback module; wherein
the configuration module is to receive configuration information, with which a UE works in a flexible duplex (FD) mode;
the receiving module is to receive data of a physical downlink shared channel (PDSCH) and control data of a physical downlink control channel (PDCCH) or enhanced physical downlink control channel (EPDCCH) indicating downlink (DL) semi-persistent scheduling (SPS) release according to a scheduling mode of the FD mode; and
the feedback module is to feed back hybrid automatic repeat request-acknowledge (HARQ-ACK) information according to an HARQ-ACK timing.

16. The user device according to claim 15,
the FD mode comprises that in a period, some sub-frames of flexible duplex-uplink (FD-UL) are DL sub-frames or special sub-frames and all sub-frames of FD-DL are DL sub-frames;
the FD-DL and FD-UL are a pair of frequency division duplexing (FDD) carriers, the FD-DL is a carrier for performing DL transmission by a backward FDD UE and the FD-UL is a carrier for performing UL transmission by the backward FDD UE.

17. The user device according to claim 16,
wherein the period is 10 ms, in one period, UL and DL sub-frames in the FD-UL follow one of conventional seven kinds of TDD UL and DL configurations, or in one period, the FD-UL comprises: 7, 8, 9 or 10 UL sub-frames.

18. The user device according to claim 17,
wherein the feedback module is to transmit HARQ-ACK information of the DL sub-frames in the FD-UL in corresponding UL sub-frames in the FD-UL when the UL and DL sub-frames in the FD-UL follow a TDD UL and DL configuration A in the convention seven kinds of TDD UL and DL configurations, a HARQ-ACK timing of DL sub-frames in the FD-UL follows the TDD UL and DL configuration A.

19. The user device according to claim 16,
wherein the period is in other length except for 10 ms, in one period, UL and DL sub-frames in the FD-UL are indicated by a bitmap configured by high-layer signaling.

20. The user device according to claim 16,
wherein as for a same UE, a DL sub-frame in the FD-DL and a DL sub-frame or special sub-frame in the FD-UL are used simultaneously.
